(19) United States
(12) Patent Application Publication
(10) Pub. No.: US 2012/0246150 A1
(43) Pub. Date: Sep. 27, 2012

(54) System and Method for Storing Data and Providing Multi-Level Access Thereto

(75) Inventors: Gabriel D. Comi, State College, PA (US); Brian C. Urch, Hampstead, MD (US)

(73) Assignee: RAYTHEON COMPANY, Waltham, MA (US)

(21) Appl. No.: 13/069,538

(22) Filed: Mar. 23, 2011

(51) Int. Cl. G06F 17/30

(52) U.S. Cl. 707/722; 707/E17.014

(57) ABSTRACT

A system for storing data in a data store and providing multi-level access thereto based on a query from a client. The system includes a database, a data module and a query module. The data module operable to receive the data, determine whether the data has a security tag, assign to each of the data not having a said security tag at least one security tag based on a rule set to thereby form tagged data, and store the tagged data in the data store based on the security tags. The query module operable to receive the query, retrieve credentials from the database based on an identity token, create filters based on the credentials, search the data store based on the query to obtain search results, apply the search results against the filters to obtain filtered results, and provide the filtered results to the client thereby providing multi-level access.

### TECHNICAL FIELD OF THE DISCLOSURE

This disclosure relates generally to data capture and access thereto. More particularly, this disclosure relates to a system and method for storing data in a database and providing multi-level access thereto.

### BACKGROUND OF THE DISCLOSURE

The ability to search information in databases is a task of ever-growing importance in the rising complexities of today's world. However, many types of information required to be searched today are of a sensitive nature thereby demanding tight security regarding who is to gain access to it. More particularly, databases of today are called upon to store various types of information that are of varying degrees of sensitivities. Such information typically requires varying levels of security clearances for access. This presents a serious problem to the information industry in that the many secure databases currently in use today generally provide for an entire database to be set at a single security level and thereby only contain information categorized at such level. This results in allowing only a select few who are cleared at such security level to access the database. Such systems typically employ the use of additional databases to store the various other levels of sensitive information, albeit one security level per database.

Such system designs have often been the case in many prior attempts to implement multi-database systems for storing multiple levels of sensitive data. Limiting the storing of information in a particular database to only that information having the same degree of sensitivity has generally proven to be a poor use of resources. These attempts have proven to be very inefficient. These prior systems require separate searches to be performed in each database in order to accomplish a complete search. Performance is greatly sacrificed with these systems over a single multi-level database due in part to such additional searches as well as the additional processing times required when gaining access to each database. Furthermore, the multi-database systems which implement a single level of sensitivity per database necessarily require additional hardware and software causing the systems to have much higher overall system costs. Also adding to the higher overall costs of such systems is the fact that they require more space.

Hence, there are a number of inadequacies associated with the systems and methods being employed today for the storing of sensitive data and provisioning of access thereto that must be overcome. Due to the aforementioned inefficiencies and high costs associated with the single database single security level system designs employed today, new solutions must be sought which strive for more efficient and powerful secure multi-level access database systems.

Accordingly, there exists a long felt need for an improved system and method for the storing of data in a data store and providing a multi-level access thereto that alleviates the inherent problems known in the systems and methods for sensitive data storing and providing access thereto that are being employed today.

### SUMMARY OF THE DISCLOSURE

According to one embodiment of the present disclosure, a system for storing data in a data store and providing multi-level access thereto based on a query from a client is presented where the data store includes a security level and the query includes search parameters and an identity token. The system is comprised of a database, a data module and a query module. The data module is operable to receive the data, determine whether the data has a security tag, assign to each of the data not having a security tag at least one security tag based on a rule set to thereby form tagged data, and store the tagged data in the data store based on the security tags. The query module is operable to receive the query from the client, retrieve credentials from the database based on the identity token, create filters based on the credentials, search the data store based on the search parameters to obtain search results, apply the search results against the filters to obtain filtered results, and provide the filtered results to the client to thereby provide multi-level access to the data.

In one embodiment of the present disclosure, the database may be in the form of an identity database having numerous names and associated credentials to work in conjunction with the identity token received in the query. This effectively provides a database of active or otherwise valid user accounts for the system. The system may then proceed with either creating filters from the credentials returned from the database or deny the client access to the system due to not having an active account in the system.

Further, in one embodiment of the present disclosure, the security tags may include one or more access control attributes and the filters may include one or more filter attributes corresponding to the access control attributes. The access control attributes and filter attributes in one embodiment may each be comprised of a plurality of levels to accommodate addressing individual data having varying degrees of sensitivity. This may then provide for the determination of filtered results by way of matching the access control attributes in the security tags of the data to the filter attributes and discarding any data not matching to form filtered results and thereby provide multi-level access to the data.

Accordingly, some embodiments of the disclosure may provide numerous technical advantages. Some embodiments may benefit from some, none or all of these advantages. For example, a technical advantage of one embodiment of the disclosure may be an improved more efficient system and method for storing data in a data store and providing multi-level access thereto that does not require individual databases to be used for each level of sensitivity. Furthermore, a system and method such as described herein may provide for a more secure access to the varying levels of sensitive data due to dealing with a single data store for the data. Another embodiment may provide for an even more secure system and method for storing data and providing multi-level access thereto that takes advantage of implementing a combination of hierarchical and direct match access control attributes in the security tags. Still further, such system and method may provide for a more enhanced tagging system for data based on the rule set dictating exactly which access control attributes are assigned to the data.

Another example of a potential technical advantage of one embodiment of the present disclosure is that it may alleviate the inherent problems associated with the current industry systems in that it may be implemented with any number of existing data stores. Many current systems and methods for storing sensitive data and providing access thereto require the use of special dedicated data stores that provide very little flexibility.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description. The foregoing has outlined rather broadly some of the more pertinent and important advantages of the present disclosure in order that the detailed description of the disclosure that follows may be better understood so that the present contribution to the art can be more fully appreciated. It should be appreciated by those skilled in the art that the conception and the specific embodiment disclosed may be readily utilized as a basis for modifying or designing other structures for carrying out the same purposes of the present disclosure. It should also be realized by those skilled in the art that such equivalent constructions do not depart from the spirit and scope of the present disclosure as set forth in the appended claims.

### BRIEF DESCRIPTION OF THE DRAWINGS

For a fuller understanding of the nature and possible advantages of the present disclosure, reference should be had to the following detailed description taken in connection with the accompanying drawings in which:

FIG. 1 is a block diagram illustrating the various components of one embodiment of a system for storing data in a data store and providing multi-level access thereto in accordance with the teachings of the present disclosure;

FIG. 2 is a flowchart showing one embodiment of a series of steps that may be performed by the data module within the system of FIG. 1 in accordance with the teachings of the present disclosure; and

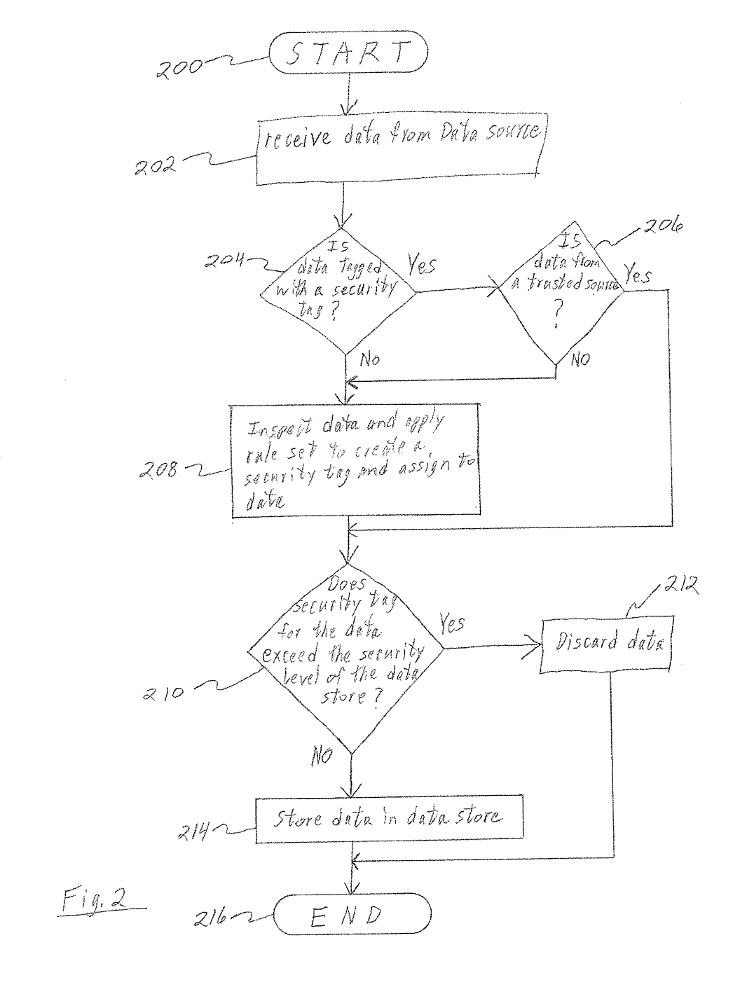

FIG. 3 is a flowchart showing one embodiment of a series of steps that may be performed by the query module within the system of FIG. 1 in accordance with the teachings of the present disclosure.

Similar reference characters refer to similar parts throughout the several views of the drawings.

### DETAILED DESCRIPTION OF THE EXAMPLE EMBODIMENTS

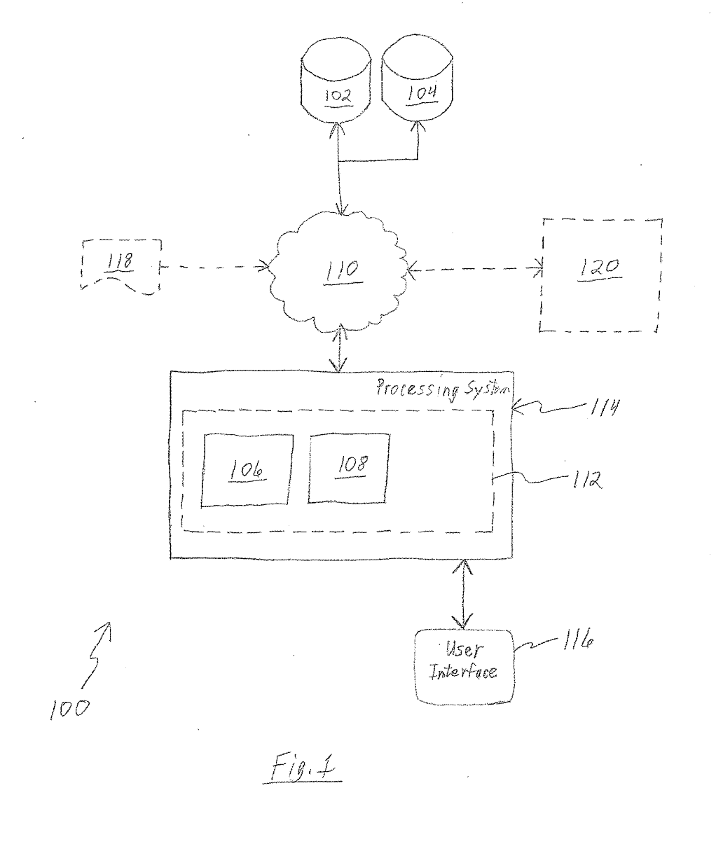

Referring to FIG. 1, a block diagram can be seen illustrating at a high level the various components of one exemplary embodiment of a system 100 for storing data in a data store and providing multi-level access thereto in accordance with the teachings of the present disclosure. In the particular embodiment of FIG. 1, system 100 is comprised of a plurality of databases (namely, a database 102 and a data store 104) in communication with and accessible by a plurality of modules (namely, a data module 106 and a query module 108) via a communication path 110.

In the particular embodiment of FIG. 1, the modules 106 and 108 are generally implemented in the form of one or more software modules residing in memory 112 associated with a processing system 114. The modules 106 and 108 can be written as a software program in any appropriate computer language, such as, for example, C, C++, C#, Java, Assembler, Tcl, Lisp, Javascript, or any other suitable language known in the software industry. The processing system may be any suitable type of computing system implemented with a processor capable of executing computer program instructions stored in a memory, which can include a personal computer, a workstation, a network computer, or any other suitable processing device. The memory may be implemented in the form of any memory for reading data from and writing data to and may include any one or combination of memory elements, such as random access memory (RAM), hard drive, tape, compact disc read/write (CD-RW), disk, diskette, cartridge, or the like resident in or associated with the processing system 114. However, in alternative embodiments, it should be understood that each of modules 106 and 108 may be separately implemented in the form of a software module residing in the memory associated with an individual standalone processing system with each operable to access databases 102 and 104 via the communication path 110. The communication path 110 is preferably implemented in the form of a computer network.

The databases 102 and 104, in the particular embodiment of FIG. 1, are generally implemented in the form of individual database files residing in the memory associated with standalone processing systems. More particularly, databases 102 and 104 may be implemented in the form of a plurality of individual processing systems, each having associated memory and a database file resident therein such as, for example, a plurality of individual database servers forming a distributed database system. Alternatively, in another embodiment, databases 102 and 104 may be implemented in the form of a plurality of database files residing in the memory associated with a single standalone processing system. Still further, in another embodiment, databases 102 and 104 may be implemented in the form of individual database files residing in the same memory associated with the one or more processing systems where modules 106 and 108 reside and wherein the communication path 110 may be implemented in the form of a bus configured within the one or more processing systems.

Database 102 in one embodiment of the present disclosure may be comprised of various account information for users of system 100 including usernames with associated passwords, certificates and credentials therefor. The credentials can vary widely depending upon the specific application system 100 is being used for. Such as, for example, one application may be in the financial services arena. In such an application, one embodiment of system 100 may employ possible credentials in the form of an access level (e.g., uncontrolled, sensitive and proprietary), a compartment (e.g., risk, accounts, and HR), and an association (e.g., client, employee, and auditor). These three categories would form the credentials for each particular individual contained in database 102, and wherein one or none of the options in each category may be designated. However, it should be understood by one skilled in the art that there are any number of alternative sets of credential criteria that may be implemented as may be suitable for a particular application of system 100. Database 102 may be established by way of any number of commonly available active directory software packages currently on the market today. For example, Microsoft® Active Directory or Oracle® Identity Manager are several products that may equally be utilized to accomplish the functionality of database 102.

Data store 104, in one embodiment of the present disclosure, is preferably suitable for facilitating data module 106 and query module 108 reading therefrom and writing thereto. Additionally, data store 104 may include a security level and a rule set assigned to it so to establish an overall security level therefor and thereby dictate how data it is to be tagged and which data is to be saved therein. The rule set may, in one embodiment, be implemented in the form of an xml schema rule set. However, it should be understood by one skilled in the art that the rule set may be implemented in any number of other alternative languages as may be appropriate and suitable for the specific application at hand for system 100. The security level and rule set for the data store 104 may be preferably set up within its initial configuration and stored in a configuration file. Alternatively, in another embodiment, such security level and rule set may be dynamically established after system 100 has been initiated for a particular application, and may further include the ability to adjust or otherwise revise such as system 100 is being utilized.

The processing system 114, in the embodiment of FIG. 1, preferably further includes a user interface 116. User interface 116 may be implemented in the form of a display, such as a cathode ray tube (CRT) or liquid crystal display (LCD) screen, and any one or more input devices, such as a keyboard, touchpad, touch screen, a pointing device, a mouse or a joystick providing for interactive control of the processing system 114.

In the embodiment of FIG. 1, system 100 is further capable of receiving various forms of information from a data source 118 (shown in ghost form) for scrutinizing, tagging and storing in the data store 104. Data source 118 may be in the form of any type of source that generates new information such as, for example, business services applications, business analytics, sensors gathering intelligence information, a manual data entry terminal, etc. System 100 also includes the ability to receive a query from a client 120 (shown in ghost form) to initiate a search of the data store 104.

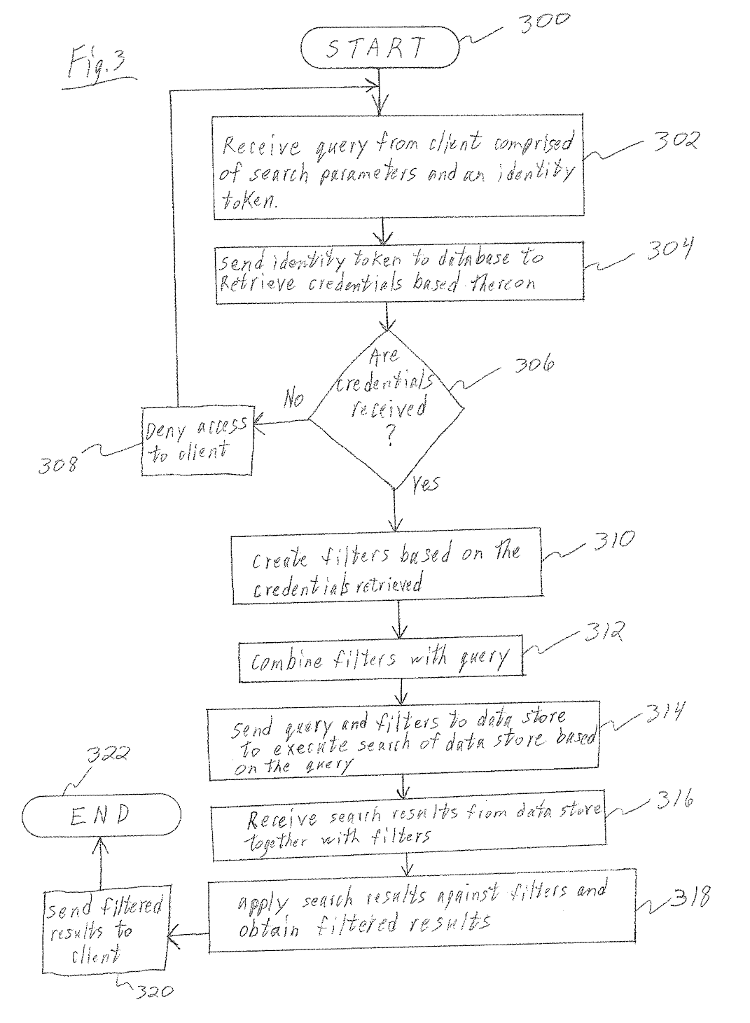

Client 120 may be in any one of a number of various forms that is capable of accessing the query module 108 and submitting a query. For example, client 120 may be in the form of an actual user at a data terminal accessing the system 100 to submit a query, a services application running on the same processing system 114 or on another stand-alone processing system communicating with the query module 108 via the communication path 110. Now that the individual components of system 100 have been described with regard to the particular embodiment of FIG. 1, the processes performed by and the interoperability of the modules 106 and 108 with the databases 102 and 104 will be addressed. To more fully understand and appreciate the detailed series of steps that may be performed by modules 106 and 108 during their operation to accomplish the teachings of the present disclosure, reference should now be made to FIGS. 3 and 4. For clarity, their operation will be discussed one at a time. However, it is to be understood that the series of steps undertaken by modules 106 and 108 may occur contemporaneously in accordance with the teachings of the present disclosure.

In referring now first to FIG. 3, a flow chart can be seen showing the details of one embodiment of a series of steps that may be performed by data module 106 in accordance with the teachings of the present disclosure. At step 200, the process is initiated. The process may be initiated by applying power to and performing any suitable bootstrapping operations to system 100. At step 202, data module 106 receives data from the data source 118. The data may take the form of any number of varying types of data associated with a particular application of the system 100. From step 202, the process proceeds to step 204.

At step 204, data module 106 scrutinizes each piece of data to determine whether a security tag is attached indicating a particular security level. In one embodiment, determining whether a security tag is attached may be accomplished by way of the data module 106 examining the data item for the presence of a tag field within it. The tag field may preferably be in the form of a predefined tag field established as part of a configuration file for the data module 106. If no, then the process proceeds directly to step 208.

If, however, it is determined that a security tag is attached, the process proceeds to step 206 where the data module 106 again examines the data item to determine whether it is from a “trusted” data source 118. In one embodiment of the present disclosure, the data module 106 may accomplish step 206 by way of checking for a valid digital “hand shake” such as with a valid public key signature or any key signature appropriate for interaction with data system 100. However, it should be understood by one skilled in art that any number of various criteria may be implemented to accomplish determining whether a data source is “trusted” as are commonly known and used in the computing industry.

If it is determined at step 206 that the data source is not “trusted”, the process proceeds to step 208. If, however, the data source is “trusted”, then the process otherwise proceeds directly to step 210. At step 208, the data module 106 inspects the nature of the data, applies a rule set to create an appropriate security tag and assigns the security tag to the data thereby forming tagged data. In one embodiment, the data may preferably be inspected by determining its type. For example, Intelligence Community Information Security Markings (ICISM) for intelligence community data, Joint Photographic Experts Group (JPEG) for medical imagery, National Imagery Transmission Format (NITF) for surveillance imagery, etc., may be several such types which are then tagged in view of being such type and as may otherwise be further dictated by the rule set for the data store 104.

In one embodiment, the security tag may preferably be comprised of one or more access control attributes as may be appropriate and suitable for a particular application of system 100. For example, in one embodiment where system 100 is utilized by a financial services organization, the security tag may implement access control attributes in the form of classification, compartment and releasability categories. One or more of such categories may further employ a plurality of levels within (such as to represent varying security sensitivity states). However, it should be understood by one skilled in the art that any number of other alternative one or more access control attributes may be implemented as deemed suitable for a particular application of system 100.

From step 208, the process then proceeds to step 210. At step 210, the data module 106 determines if the security tag for the tagged data exceeds the security level assigned to the data store 104. If yes, then the process proceeds to step 212 where the data module 106 discards the tagged data. From step 212, the proceeds then proceeds directly to step 216. If, however, it is determined at step 210 that the security tag for the tagged data does not exceed the security level of the data store 104, then the process proceeds to step 214. At step 214, the data module 106 stores the tagged data along with its security tag in the data store 104. From step 214, the process then proceeds to step 216 where the process ends for the data module 104 in accordance with the teachings of the present disclosure.

In referring now to FIG. 4, a flow chart can be seen showing the details of one embodiment of a series of steps that may be performed by the query module 108 in accordance with the teachings of the present disclosure. At step 300, the process is initiated. The process may be initiated by applying power to and performing any suitable bootstrapping operations to system 100. At step 302, the query module 108 receives a query from the client 120 comprised of search parameters and an identity token. The identity token may preferably be in the form of a username with a password, a certificate or other similar item as may be commonly known and used today for verification purposes in the secure computing industry. However, alternative embodiments may implement the identity token in any number of other forms as may be appropriate and suitable for operation with the database 102 to accomplish secure identity verification. From step 302, the process proceeds to step 304. At step 304, query module 108 sends the identity token to the database 102 to check for and retrieve credentials based thereon. From step 304, the process proceeds to step 306.

At step 306, the query module 108 determines if credentials were retrieved from the database 102. If yes, the process proceeds to step 310. However, if no credentials were retrieved from database 102 based on the identity token, then the process proceeds to step 308. At step 308, query module 108 denies client 120 access to system 100. From step 308, the process then proceeds back to step 302 for receiving another query from a client 120. At step 310, the query module 108 creates filters based on the credentials retrieved from database 102. As for example, in an application of system 100 to a financial services organization, one embodiment of system 100 may retrieve credentials in the categories of an access level (uncontrolled, sensitive and proprietary), a compartment (risk, accounts, and HR), and an association (client, employee, and auditor) where one or none of the options in each category may be designated. The filters created may preferably be in the form of one or more filter attributes corresponding to the access control attributes in the security tags. From step 310, the process proceeds to step 312.

At step 312, query module 108 combines the query with the filters. That is, the search parameters submitted as part of the initial query received by system 100 are combined with the newly created filters. In one embodiment, this may preferably be accomplished by simply appending the filters to the end of the search parameters. From step 312, the process proceeds to step 314. At step 314, the query module 108 sends the query (i.e., search parameters) and the filters to the data store 104 to execute a search thereof based on the query. From step 314, the process proceeds to step 316.

At step 316, the query module 108 receives the search results from the data store 104 along with the filters intact. The search results may be comprised of any tagged data contained in the data store 104 that was identified based on the search parameters. From step 316, the process proceeds to step 318. At step 318, the query module 108 then applies the search results against the filters to obtain filtered results. In one embodiment, query module 108 may apply the search results against the filters by way of matching the filter attributes to corresponding access control attributes in the security tags of the tagged data contained in the search results. When the access control attributes of the tagged data contained in the search results fail to match the filter attributes, the tagged data is removed from the search results.

This matching process continues until all the tagged data contained in the search results have been applied against the filters. The remaining tagged data forms the filtered results. The matching process may be implemented in a number of ways depending on the nature of the access control attributes. That is, the access control attributes may be in the form of direct match access control attributes where a direct match is required, or in the form of hierarchical access control attributes where a match is achieved, for example, by having a filter level that is equal to or less than a particular level of an access control attribute. The exact nature of the individual filter attributes and access control attributes implemented in system 100 will largely depend upon that which is most appropriate and suitable for a particular application. With that said, whichever filter attributes and access control attributes are implemented in a particular system 100, they are to be chosen so as to be appropriate for the application at hand and correspond to one another in a way to ultimately accomplish the filtering of the search results based on the credentials retrieved from the database 102. From step 318, the process proceeds to step 320. At step 320, the query module 108 sends the filtered results to the client 120. From step 320, the process proceeds to step 322 where the process ends in accordance with the teachings of the present disclosure.

### Example

The following is a discussion of one illustrative example of the teachings of the present disclosure as may be applied to a financial services organization whereby one exemplary form of filters are created based on the credentials of various users (i.e., clients 120). In such a scenario, the data may be tagged using three different access control attributes, namely, “Classification”, “Compartment”, and “Releasability”. Classification may be the overall sensitivity of the data as related to the risk (such as in legal, financial, or national security) associated with disclosing the data to someone not authorized to see it Compartments may be applied within a classification to restrict access to data to only those communities with a need to use it. Releasability may relate to subgroups (possibly nationality based) which are allowed to access the data. In this particular example of an implementation of the teachings of the present disclosure, Classification may be in the form of a hierarchical access control attribute such that anyone with a certain clearance level is allowed to see the classification they are cleared for and anything below that level in the hierarchy. Compartment and Releasability may require a direct match to the user's approved level. Furthermore, the Compartment and Releasability categories may differ in that the users may have more than one Compartment access control attribute assigned to them while only having a single Releasability related access control attribute assigned.

Again, assuming system 100 is being applied to a financial services organization, the different Classification levels may be “uncontrolled”, “sensitive”, and “proprietary”. The different Compartments may be “risk”, “accounts”, and “HR”. The Releasability may be based on the user's “association” with the organization such as with “client”, “employee”, and “auditor”. Now assume there is tagged data in the data store 104 having security tags as set forth in Table 1.

TABLE 1
Tagged Data

| Item | Security Tag Attributes |
|---|---|
| A | Classification: uncontrolled; |
| | Compartments: none; |
| | Releasability: client, employee, auditor |
| B | Classification: sensitive; |
| | Compartment: risk; |
| | Releasability: employee, auditor |
| C | Classification: proprietary; |
| | Compartment: risk, accounts; |
| | Releasability: employee, auditor |
| D | Classification: proprietary; |
| | Compartment: HR; |
| | Releasability: employee |

Now assume that there are three different users contained in database 102 having credentials such as set forth in Table 2.

TABLE 2
User Credentials

| User | Credentials |
|---|---|
| 1 | Access Level: sensitive |
| | Compartments: risk |
| | Association: employee |
| 2 | Access Level: proprietary |
| | Compartments: risk, accounts, HR |
| | Association: auditor |
| 3 | Access Level: Uncontrolled |
| | Compartments: none |
| | Association: client |

Given that all three users execute the same initial query having the same search parameters that would return all items A, B, C, and D, the following would occur: i) user 1's credential based filters would be [[Classification=(sensitive OR uncontrolled) AND (Compartment does NOT contain Accounts OR HR) AND (Releasability contains employee)]] and cause the filtered results for user 1 to contain only items A and B; ii) user 2's credential based filters would be [[Classification=(proprietary OR sensitive OR uncontrolled) AND (Releasability contains auditor)]] (noting that since user 2 is approved for all compartments, none are excluded) and cause the filtered results for user 2 to contain only items A, B and C; and iii) user 3's credential based filters would be [[Classification=(uncontrolled) AND (Compartments does NOT contain risk OR accounts OR HR) AND (Releasability contains client)]] and cause the filtered results for user 3 to contain only item A.

The present disclosure includes that contained in the appended claims, as well as that of the foregoing description. Although this disclosure has been described in its preferred form in terms of certain embodiments with a certain degree of particularity, alterations and permutations of these embodiments will be apparent to those skilled in the art. Accordingly, it is understood that the above descriptions of exemplary embodiments does not define or constrain this disclosure, and that the present disclosure of the preferred form has been made only by way of example and that numerous changes, substitutions, and alterations in the details of construction and the combination and arrangement of parts may be resorted to without departing from the spirit and scope of the invention.

What is claimed is:

1. A system for storing data in a data store and providing multi-level access thereto based on a query from a client, the data store having a security level and the query including search parameters and an identity token, the system comprising:
a database;
a data module that receives the data, determines whether the data has a security tag, assigns to each of the data not having a said security tag at least one said security tag based on a rule set to thereby form tagged data and stores said tagged data in the data store based on said security tags; and
a query module that receives the query, retrieves credentials from said database based on the identity token, creates filters based on said credentials, searches the data store based on the search parameters to obtain search results, applies said search results against said filters to obtain filtered results, and provides said filtered results to the client thereby providing multi-level access to the data stored in the data store.

2. The system of claim 1, wherein said data module stores said tagged data in the data store based on said security tags by way of storing in the data store only that of said tagged data which does not have security tags exceeding the security level of the data store.

3. The system of claim 1, wherein said query module creates filters based on said credentials by way of initially denying the client access to search the data store if no credentials are retrieved based on the identity token.

4. The system of claim 1, wherein said security tag includes one or more access control attributes.

5. The system of claim 4, wherein said filters include one or more filter attributes that correspond to said access control attributes.

6. The system of claim 5, wherein said query module applies said search results against said filters to obtain filtered results by way of matching said filter attributes to corresponding said access control attributes of said tagged data in said search results and removing said tagged data having said access control attributes that do not match said filter attributes.

7. The system of claim 6, wherein at least one of said filter attributes and at least one of said access control attributes correspond to each other and include a plurality of levels within, said levels representing varying security sensitivity states.

8. A method for storing data in a data store and providing multi-level access thereto based on a query from a client, the data store having a security level and the query including search parameters and an identity token, the method comprising the steps of:
determining if the data has a security tag;
assigning to each of the data not having a said security tag at least one said security tag based on a rule set to thereby form tagged data;
storing said tagged data in the data store based on said security tags;
retrieving credentials from a database based on the identity token;
creating filters based on said credentials;
searching the data store based on the search parameters to obtain search results;
applying said search results against said filters to obtain filtered results; and
providing said filtered results to the client thereby providing multi-level access to the data stored in the data store.

9. The method of claim 8, wherein the step of storing said tagged data in the data store based on said security tags is comprised of storing in the data store only that of said tagged data which does not have security tags exceeding the security level of the data store.

10. The method of claim 8, wherein the step of creating filters based on said credentials comprises the step of initially denying the client access to search the data store if no credentials are retrieved based on the identity token.

11. The method of claim 8, wherein said security tag includes one or more access control attributes.

12. The method of claim 11, wherein said filters include one or more filter attributes that correspond to said access control attributes.

13. The method of claim 12, wherein the step of applying said search results is comprised of matching said filter attributes to corresponding said access control attributes of said tagged data in said search results and removing said tagged data having said access control attributes that do not match said filter attributes.

14. The method of claim 13, wherein at least one of said filter attributes and at least one of said access control attributes correspond to each other and include a plurality of levels within, said levels representing varying security sensitivity states.

15. Code embodied in a computer readable storage medium that, when executed by a processor, is operable to:
receive data and determine if the data has a security tag;
assign to each of the data not having said security tag at least one said security tag based on a rule set to thereby form tagged data;
store said tagged data in a data store based on said security tags;
receive a query having search parameters and an identity token from a client;
retrieve credentials from a database based on the identity token;
create filters based on said credentials;
search the data store based on the search parameters to obtain search results;
apply said search results against said filters to obtain filtered results; and
provide said filtered results to the client.

16. The code of claim 15, further operable to store said tagged data in the data store based on said security tags by way of storing in the data store only that of said tagged data which does not have security tags exceeding the security level of the data store.

17. The code of claim 15, further operable to assign said security tag comprised of one or more access control attributes.

18. The code of claim 17, further operable to create said filters having one or more filter attributes that correspond to said access control attributes.

19. The code of claim 18, further operable to apply said search results by way of matching said filter attributes to corresponding said access control attributes of said tagged data in said search results and removing said tagged data having said access control attributes that do not match said filter attributes.

20. The code of claim 19, further operable to create at least one of said filter attributes and assign at least one of said access control attributes so as to correspond to each other and include a plurality of levels within, said levels representing varying security sensitivity states.
